(19) United States
(12) Patent Application Publication
(10) Pub. No.: US 2015/0111003 A1
(43) Pub. Date: Apr. 23, 2015

(54) MARKING STRUCTURE FOR TOOL SURFACE

(71) Applicant: WANG, YAO-HUNG, Taichung City (TW)

(72) Inventor: WANG, YAO-HUNG, Taichung City (TW)

(21) Appl. No.: 14/055,898

(22) Filed: Oct. 17, 2013

(51) Int. Cl. B25B 23/00; B44C 1/22

(52) U.S. Cl. CPC B25B 23/00; B44C 1/228
USPC 428/164

(57) ABSTRACT

A marking structure for a tool surface of a tool contains a marking area laser marked on a tool surface, a color zone pad printed or screen printed a color material in the marking area. The color zone is overlapped with the printing area. In another embodiment, a marking structure for a tool surface of a tool contains a color zone formed by printing a color material on the tool surface and a marking area connecting with the color zone. The color zone includes any one of a pattern, at least one number, at least one letter, a combination of the pattern and the at least one number, and a combination of the at least one letter and the pattern.

### FIELD OF THE INVENTION

The present invention relates to a marking structure for a tool surface which has variable color appearance so that a user distinguishes a size of a tool clearly.

### BACKGROUND OF THE INVENTION

As illustrated in FIGS. 1 and 2, a conventional marking structure contains a marking portion 12 laser marked on a tool surface 11, wherein a color of the marking portion 12 is different from that of the tool surface 11 so that the user distinguishes a size of a tool 10.

However, the color of the marking portion 12 is slightly different from that of the tool surface 11, so when the user views the marking structure at different angles, he/she cannot distinguish the size of the tool 10 clearly.

The present invention has arisen to mitigate and/or obviate the afore-described disadvantages.

### SUMMARY OF THE INVENTION

The primary object of the present invention is to provide a marking structure for a tool surface which has variable color appearance so that a user distinguishes a size of a tool clearly. To obtain the above objectives, a marking structure for a tool surface provided by the present invention contains: a marking area laser marked on a tool surface, a color zone pad printed or screen printed a color material in the marking area. The color zone is overlapped with the printing area. In another embodiment, a marking structure for a tool surface of a tool contains a color zone formed by printing a color material on the tool surface and a marking area connecting with the color zone.

The color zone includes any one of a pattern, at least one number, at least one letter, a combination of the pattern and the at least one number, and a combination of the at least one letter and the pattern.

### BRIEF DESCRIPTION OF THE DRAWINGS

FIG. 1 shows a conventional marking structure of a tool surface.

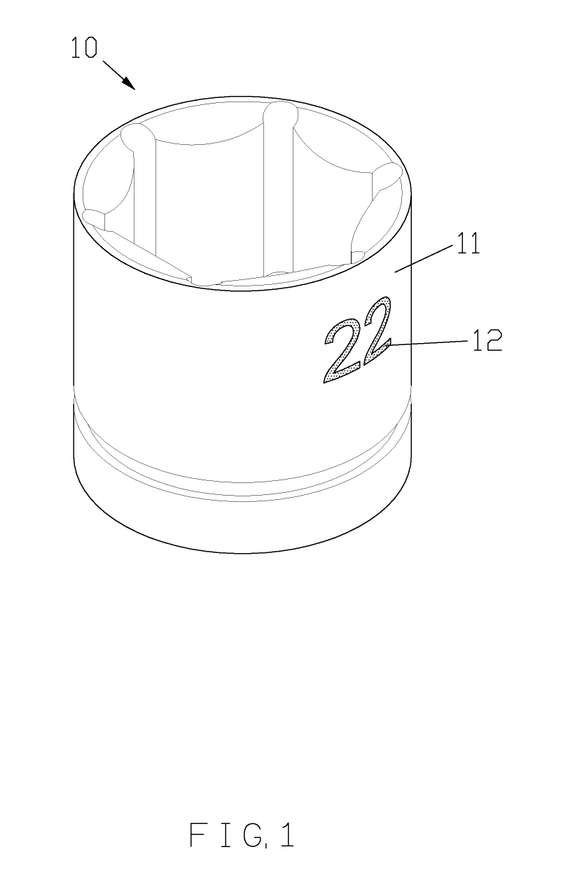

FIG. 2 shows the conventional marking structure of the tool surface.

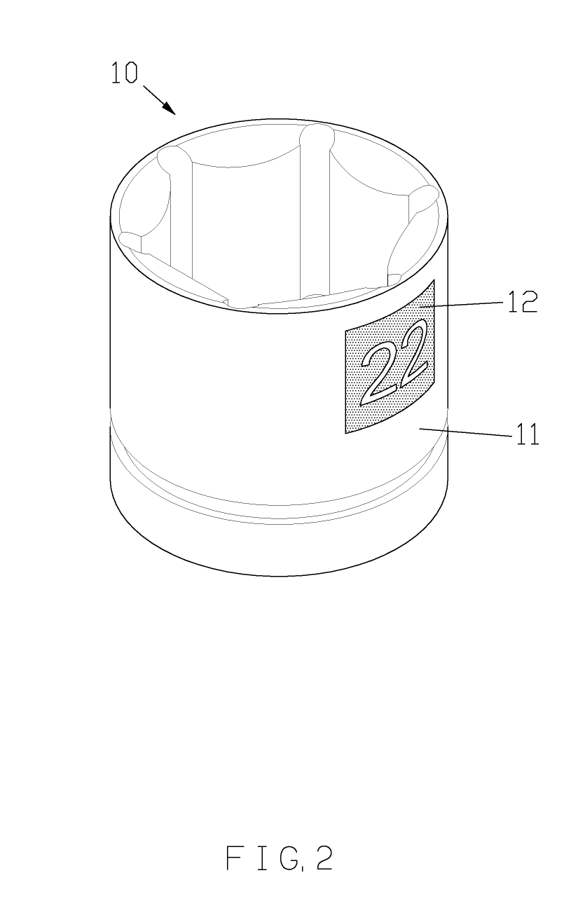

FIG. 3 is a perspective view showing the assembly of a part of a marking structure for a tool surface according to a first embodiment of the present invention.

FIG. 4 is a perspective view showing the assembly of a part of a marking structure for a tool surface according to a second embodiment of the present invention.

FIG. 5 is a perspective view showing the assembly of the marking structure for the tool surface according to the first embodiment of the present invention.

FIG. 6 is a perspective view showing the assembly of the marking structure for the tool surface according to the second embodiment of the present invention.

FIG. 7 is a cross sectional view showing the assembly of a part of the marking structure for the tool surface according to the first embodiment of the present invention.

FIG. 8 is a cross sectional view showing the assembly of a part of the marking structure for the tool surface according to the second embodiment of the present invention.

FIG. 9 shows a color zone including a plurality of color layers, and each color layer having a varying color according to the first embodiment and the second embodiment of the present invention.

FIG. 10 is a plan view showing the application of the marking structure for the tool surface according to the first embodiment and the second embodiment of the present invention.

### DETAILED DESCRIPTION OF THE PREFERRED EMBODIMENTS

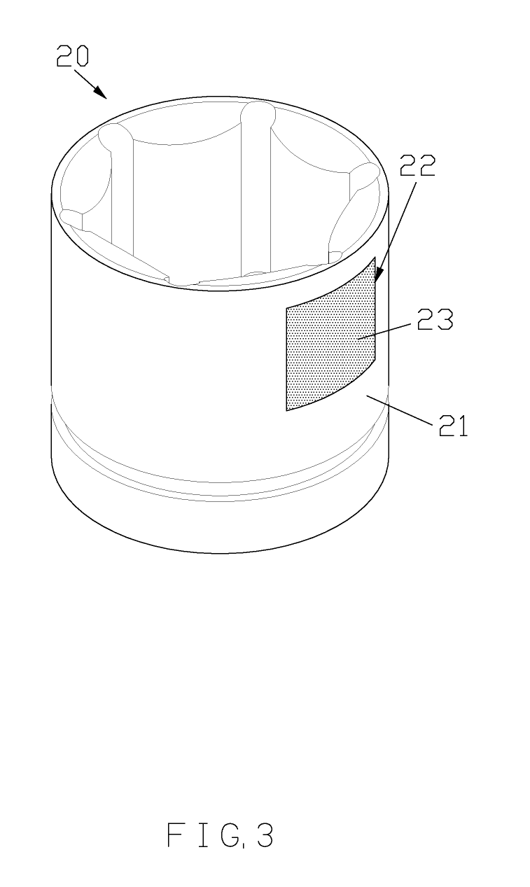

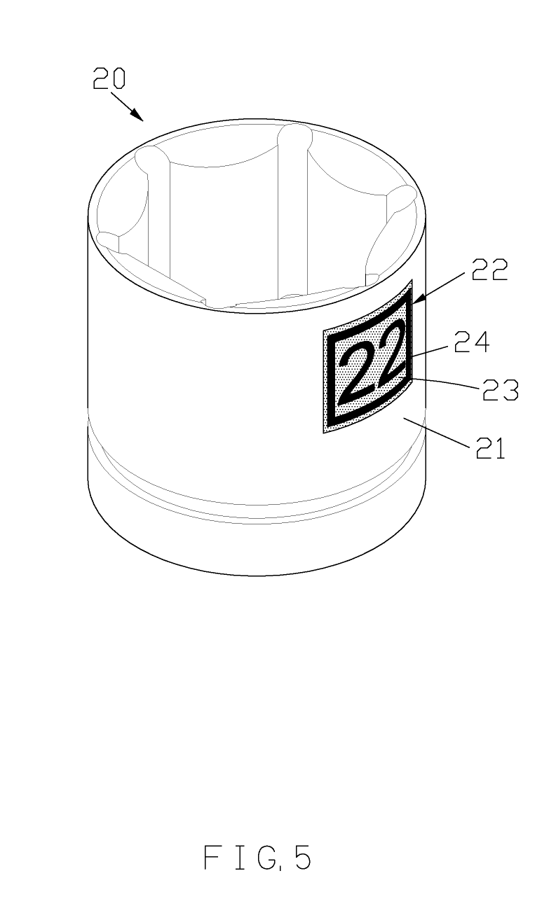

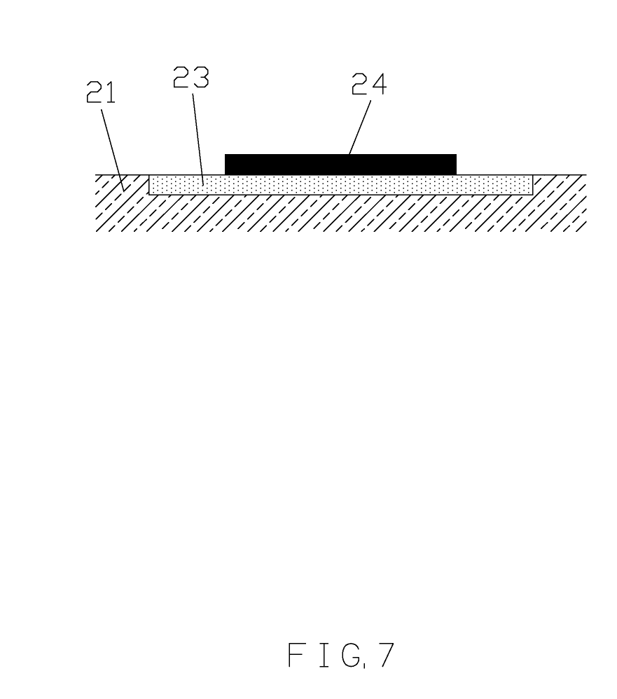

Referring to FIGS. 3, 5 and 7, a marking structure for a tool surface 21 of a tool 20 according to a first embodiment of the present invention comprises: a marking area 23 laser marked on the tool surface 21, a color zone 24 pad printed or screen printed a color material in the marking area 23, wherein the color zone 24 is overlapped with the marking area 23 and includes any one of a pattern, at least one number, and a pattern and at least one number.

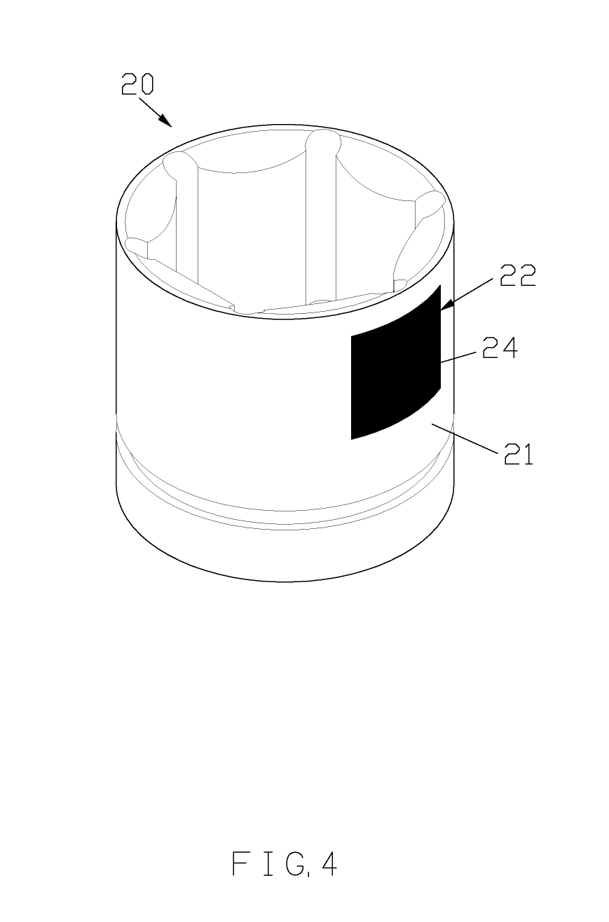

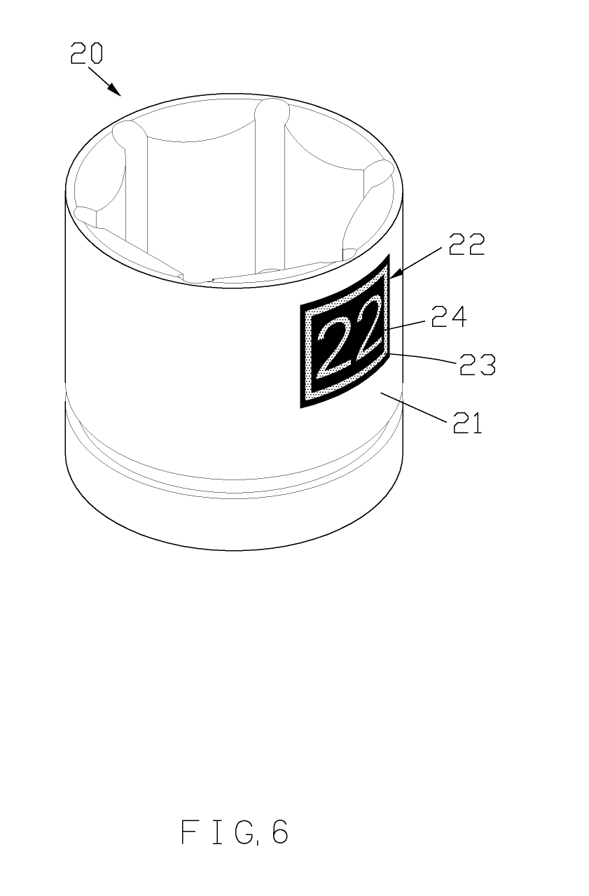

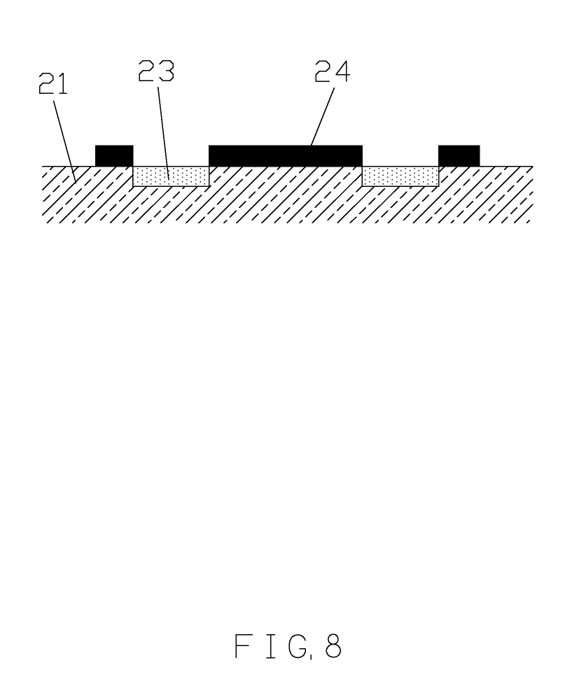

Referring further to FIGS. 4, 5, 6 and 8, a marking structure for a tool surface 21 of a tool 20 according to a second embodiment of the present invention comprises: a color zone 24 formed by printing a color material on the tool surface 21 and a marking area 23. The color zone 24 includes any one of a pattern, at least one number, and a pattern and at least one number which is formed by removing any one of a pattern region, at least one number region, and a pattern region and at least one number region in a laser marking manner. In addition, any one of the pattern, the at least one number, and the pattern and the at least one number of the color zone 24 is formed by removing a remove portion beyond any one of the pattern region, the at least one number region, and the pattern region and the at least one number region in a laser marking manner, such that the remove portion forms in the marking area 23 which connects with the color zone 24.

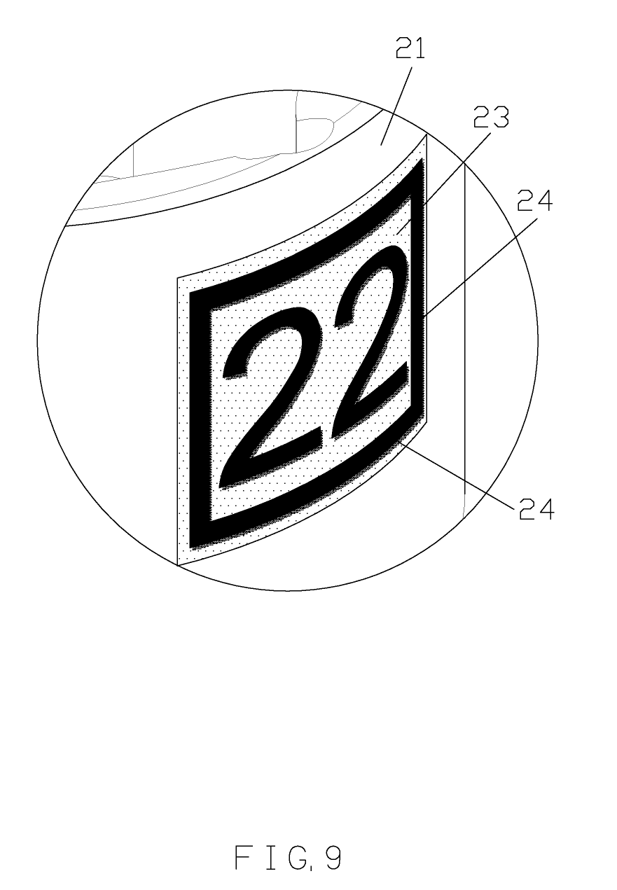

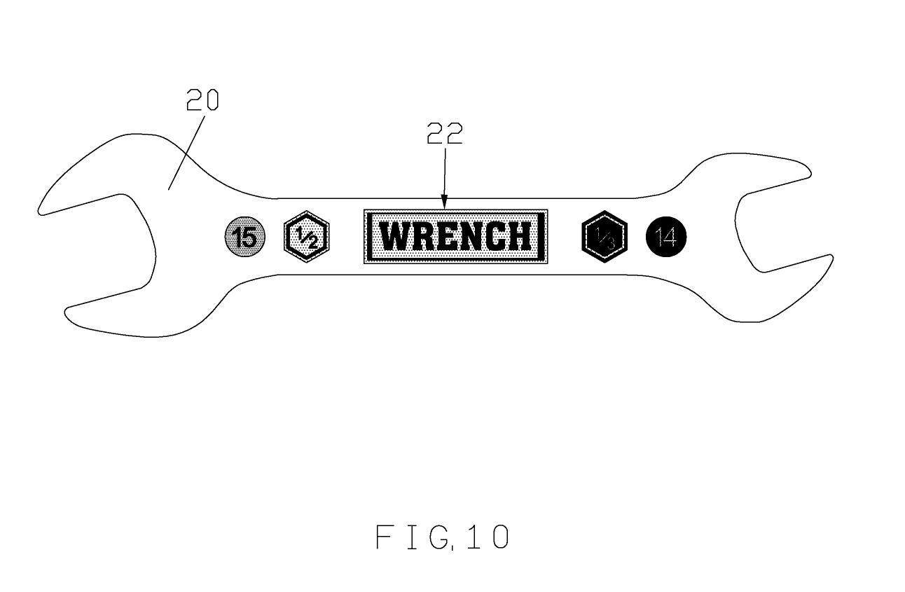

As shown in FIGS. 9 and 10, the color zone 24 includes a plurality of color layers, and each color layer has a varying color so that the marking structure has variable color appearance. Preferably, the color zone 24 also includes at least one letter or the at least one letter and the pattern.

While the preferred embodiments of the invention have been set forth for the purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. A marking structure for a tool surface of a tool comprising:
a marking area laser marked on a tool surface, a color zone pad printed or screen printed a color material in the marking area, wherein the color zone is overlapped with the printing area;
wherein the color zone includes any one of a pattern, at least one number, and a combination of the pattern and the at least one number.

2. The marking structure for the tool surface as claimed in claim 1, wherein the color zone also includes a plurality of color layers, and each color layer has a varying color.

3. The marking structure for the tool surface as claimed in claim 1, wherein the color zone also includes at least one letter or the at least one letter and the pattern.

4. A marking structure for a tool surface of a tool comprising:
a color zone formed by printing a color material on the tool surface and a marking area connecting with the color zone;
wherein the color zone includes any one of a pattern, at least one number, and a combination of the pattern and the at least one number.

5. The marking structure for the tool surface as claimed in claim 4, wherein any one of the pattern, the at least one number, and the pattern and the at least one number of the color zone is formed by removing any one of a pattern region, at least one number region, and a pattern region and at least one number region in a laser marking manner.

6. The marking structure for the tool surface as claimed in claim 4, wherein any one of the pattern, the at least one number, and the pattern and the at least one number of the color zone is formed by removing a remove portion beyond any one of the pattern region, the at least one number region, and the pattern region and the at least one number region in a laser marking manner.

7. The marking structure for the tool surface as claimed in claim 4, wherein the color zone also includes a plurality of color layers, and each color layer has a varying color.

8. The marking structure for the tool surface as claimed in claim 4, wherein the color zone also includes at least one letter.

9. The marking structure for the tool surface as claimed in claim 4, wherein the color zone also includes at least one letter and the pattern.
